(19) United States
(12) Patent Application Publication
(10) Pub. No.: US 2026/0072408 A1
(43) Pub. Date: Mar. 12, 2026

(54) WATCH HEAD CONFIGURED FOR ASSEMBLY AND DISASSEMBLY IN OPPOSITE DIRECTIONS

(71) Applicant: ETA SA MANUFACTURE HORLOGÈRE SUISSE, Grenchen (CH)

(72) Inventors: Roger WILLEMIN, Grenchen (CH); Martial Bringolf, Le Landeron (CH)

(73) Assignee: ETA SA MANUFACTURE HORLOGÈRE SUISSE, Grenchen (CH)

(21) Appl. No.: 19/283,787

(22) Filed: Jul. 29, 2025

(30) Foreign Application Priority Data
Sep. 9, 2024 (EP) 24199215.5

(51) Int. Cl. G04B 37/00; G04B 37/22

(52) U.S. Cl. CPC G04B 37/0033; G04B 37/22

(57) ABSTRACT

A watch head (1) which can be assembled from the top and disassembled from the bottom, the watch head (1), including: a case (2) having a middle (3) delimiting an inner bed (3a), the back (4) fitted with reversible fastener on the middle (3) and a movement rest (5) mounted flush with a lower face on the middle (3); a movement (7) mounted on the movement rest (5) within the pre-assembled case (2); a dial (8) mounted on the movement (5); and a glass (10) closing the pre-assembled case (2) at the end opposite to the back (4). The dial (8) and the movement (7) have dimensions less than or equal to the dimensions of the bed (3a) inside the middle (3) so that the middle (3) can be traversed from above and from below.

### CROSS REFERENCE TO RELATED APPLICATIONS

This application claims priority to European Patent Application No. 24199215.5, filed on Sep. 9, 2024, the entire contents of which are incorporated herein by reference.

### TECHNICAL FIELD OF THE INVENTION

The invention relates to a watch head configured for assembly from the top and disassembly/reassembly from the bottom.

### TECHNOLOGICAL BACKGROUND

When assembling a watch head, designers have to decide whether to assemble it from the top or from the bottom, namely from the bezel side or from the back. In fact, for the horologist, disassembly will be carried out in the same direction, namely from the top or from the bottom.

It is never foreseen to assemble in one direction and disassemble in the other. However, assembly and disassembly in opposite directions offer greater freedom for the horologist. This is particularly advantageous for battery-powered watches, as disassembly from the bottom allows for quick access to a battery that is secured inside the watchcase and not placed in a battery compartment at the back.

### SUMMARY OF THE INVENTION

The present invention aims to overcome a preconception held by persons skilled in the art by proposing a new watch head arrangement enabling assembly from the top and disassembly/reassembly from the bottom.

To this end, a pre-assembled watchcase is provided with a back assembled with reversible fastening means, such as a bayonet connection, on the middle.

More specifically, the present invention relates to a watch head which can be assembled from the top and disassembled from the bottom, with the bottom defining a lower position facing a back and with the top defining an upper position opposite to the lower position, the watch head comprising:
a pre-assembled case comprising a middle delimiting an inner bed, the back fitted with reversible fastening means on said middle and a movement rest mounted flush with a lower face on the middle,
a movement mounted on the movement rest within the pre-assembled case,
a dial mounted on the movement,
a glass closing the pre-assembled case at the end opposite to the back,
   said dial and said movement having dimensions less than or equal to those of the dimensions of the bed inside the middle so that the middle can be traversed from above and from below.

This arrangement allows the watch head to be turned over and disassembled or reassembled from the bottom. This ensures freedom of assembly and disassembly.

For quartz movements, it also enables a new and advantageous variant to be created, eliminating the battery compartment and securing the battery inside the watch head.

Furthermore, it makes it possible to design the back separately from the middle.

### BRIEF DESCRIPTION OF THE FIGURES

FIG. 1A shows an exploded view of the various parts of the pre-assembled case. FIG. 1B shows a view of the upper face of the movement rest and FIG. 1C shows a view of the back.

FIG. 2 shows the pre-assembled case.

FIG. 3 schematically illustrates the assembly from the top of the external part and of the movement on the pre-assembled case.

FIG. 4 shows the watch head resulting from the assembly.

FIG. 5 schematically illustrates the disassembly of the watch head from the bottom.

FIG. 6 shows a partial vertical cross-sectional view of the movement rest mounted flush with the middle.

FIG. 7 shows the dial attached to the movement.

FIG. 8 shows a three-dimensional view of the bolt according to one variant.

FIG. 9 shows a horizontal cross-sectional view of the watch head with this bolt variant.

FIG. 10 shows a partial vertical cross-sectional view of this bolt variant within the watch head with the positioning of the tool for removing the bolt.

FIG. 11 shows a horizontal cross-sectional view of the watch head fitted with the bolt according to another variant, with an enlargement at the bolt on the bayonet connection.

### DETAILED DESCRIPTION OF THE INVENTION

The invention relates to a watch head 1 that can be assembled from the top, namely from the bezel side, and disassembled and reassembled from the bottom, namely from the back side. The invention also relates to the assembly and disassembly method. Hereinafter, the position facing the back will be referred to as the bottom position and the position facing the bezel as the top position.

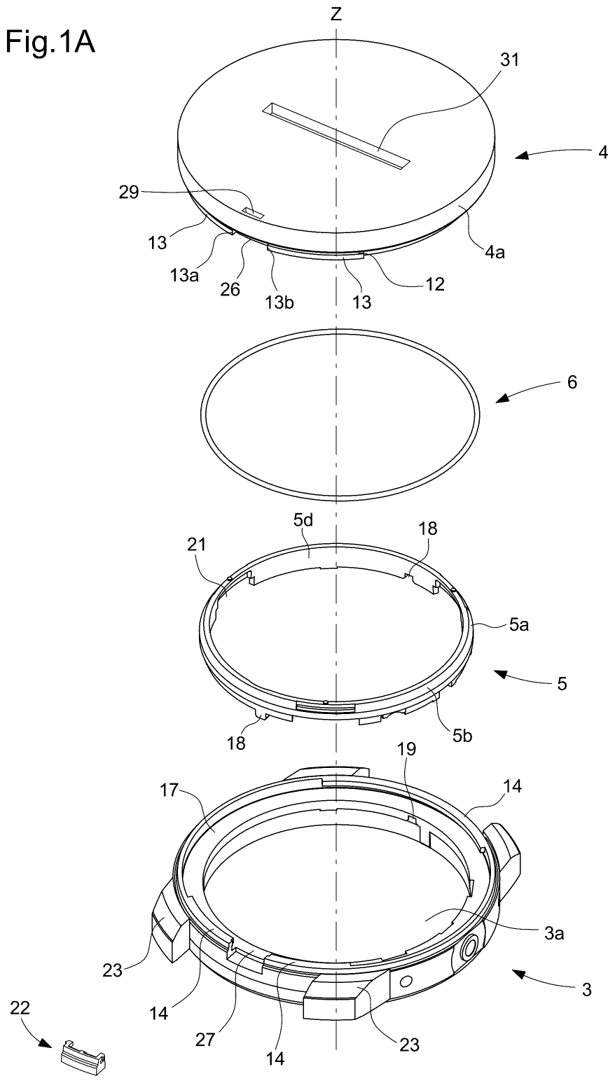

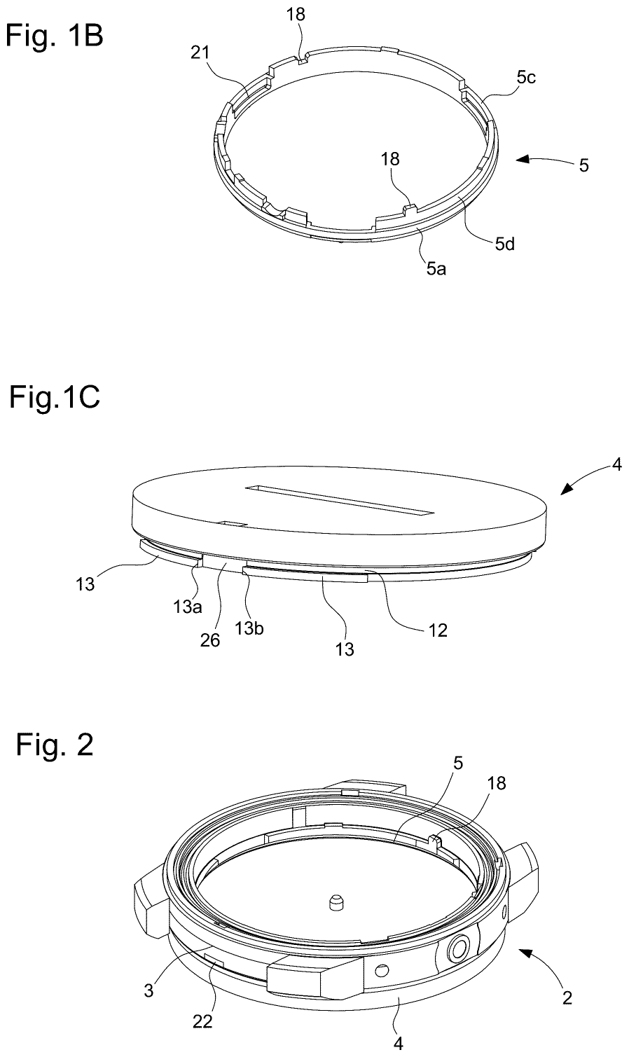

The watch head 1 is assembled from a pre-assembled watch case 2. The watch head, which can be seen in an exploded view in FIG. 3, is formed from the pre-assembled case 2, the movement 7, the dial 8 and hands 9 mounted in the case, the glass 10 closing the watch head and optionally a bezel 11. The pre-assembled case 2, also seen in an exploded view in FIG. 1A, comprises a back 4, a middle 3, a movement rest 5 and a sealing joint 6, for example an O-ring. The middle 3 and the back 4 of the pre-assembled case can be made of a synthetic material, or in other words plastic, or of metal, and the bezel on the watch head can be made of the same material as the middle and back or of a separate material.

The pre-assembled case 2 is closed by the back 4, which is mounted on the middle 3 by reversible fastening means. Preferably, the back 4 is assembled on the middle 3 with a bayonet connection. Other fastening means, such as screws, can also be used, but they are less favourable because they take up more space and require metal elements, which precludes a 100% plastic back. Preferably, the pre-assembled case 2 comprises a bolt 22 that prevents any relative rotational movement of the back relative to the middle. Preferentially, it is positioned between the horns 23 of the middle 3 so as to be concealed once the wristlet has been attached.

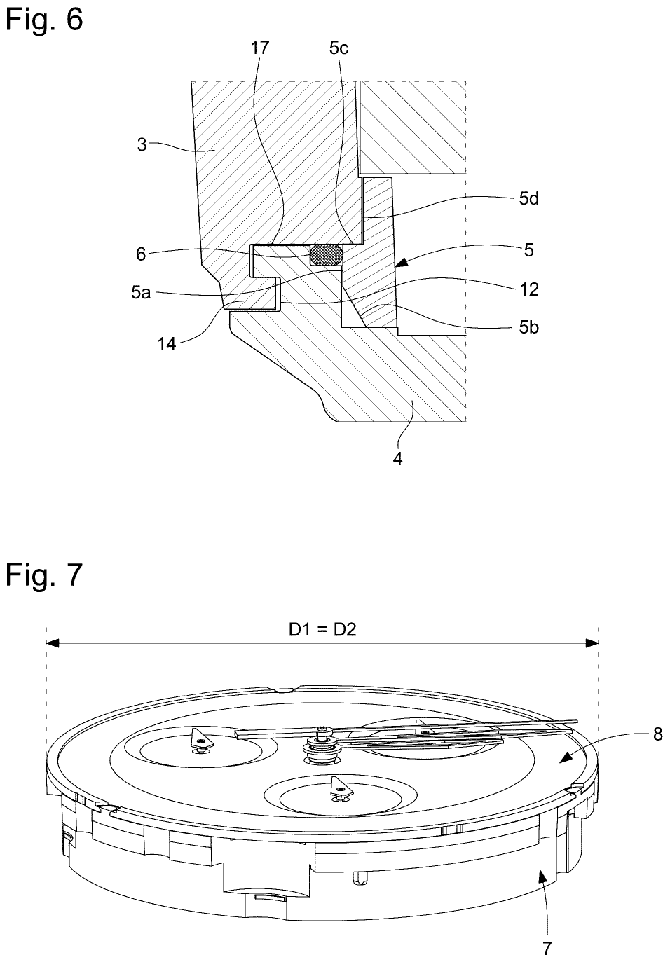

To ensure the bayonet connection, the back 4 comprises a groove 12 formed in a flange 13 extending in a circular arc around the periphery 4a of the back 4 towards the middle. The groove 12 is open at one end of the circular arc to enable a flange 14 protruding into the middle 3 to engage, and optionally closed at the other end by a stop (not shown). FIG. 6 shows a cross-sectional view of this bayonet connection, with the flange 14 on the middle 3 engaged in the groove 12 in the back 4. Preferentially, there is a large number of flanges 13 and 14 around the perimeter 4a of the back and inside the middle 3, respectively. In the example shown, there are 2 diametrically opposite flanges 13 and 14.

The middle 3 shown in FIG. 1A comprises a through bed 3a accommodating the movement rest 5 and the O-ring 6, with the bed 3a closed at one end by the back 4. The lateral wall of the bed 3a is provided with flanges 14 extending radially from the lower end of the lateral wall. A rim 17 is recessed into this lateral wall, on which the joint 6 is pressed and with which the movement rest 5 is flush.

The movement rest 5, which is substantially annular in shape, has a periphery 5a. A frustoconical portion 5b, which can be seen in FIGS. 1A and 6, extends from this periphery 5a on the lower face of the movement rest. On the opposite face seen in FIG. 1B, that is, on the upper face, a shoulder 5c is recessed at the periphery 5a, surmounted by a wall 5d. The shoulder 5c presses against the rim 17 of the middle 3 to ensure that the movement rest 5 is mounted flush with the middle 3. As shown in FIG. 6, the shoulder 5c presses against the periphery of the rim 17 with the joint 6 fitted in the space between the back 4, the middle 3 and the movement rest 5. According to the invention, the frustoconical portion 5b of the movement rest 5 makes it easier for the joint 6 to slide beyond the periphery 5a when it is fitted. According to the invention, the internal geometry of the movement rest is adapted to the geometry of the movement it holds.

The movement rest 5 comprises, on its wall 5d, guide marks 18 in the form of notches or tabs that are positioned in complementarily shaped guide marks 19, 20 in the middle 3 (FIG. 1A) and in the movement 7 (FIG. 5), respectively, so as to index the movement rest relative to the middle and to the movement during assembly. Moreover, openings 21 can be made in the wall 5d to give flexibility to the movement rest 5.

According to the invention, the movement rest is mounted flush with a lower face on the middle, enabling it to be assembled and disassembled solely from the back. On the other hand, the dial and movement have features that enable them to be assembled and disassembled in both directions. According to the invention, the dial 8 and the movement 7 have dimensions less than or equal to those of the dimensions of the bed 3a inside the middle 3 so that the middle 3 can be traversed from above and from below. If the movement and dial are substantially circular in shape, the movement 7 and dial 8 respectively have a diameter D1 and D2 equal to or less than the inner diameter D3 of the middle. Diameters D1 and D2 are taken to mean the diameter of the largest circle virtually drawn around the movement and the dial. Diameter D3 refers to the diameter of the smallest circle virtually drawn inside the middle. Therefore, if there is a protruding portion inside the middle, the circle will be drawn from the end of the protruding portion. Ideally, the diameter D2 of the dial 8 corresponds to the diameter D1 of the movement 7 as shown in FIG. 7.

As previously mentioned, the bayonet connection of the pre-assembled case can be locked with a bolt 22 which is an attachment or a part joined to the back. In a first variant which can be seen in FIGS. 1A-2 and 8-9, the bolt 22 is a part attached to the middle 3 and to the back 4. To this end, the groove 12 in the back 4 communicates with a notch 26 in the flange 13 (FIG. 1C). The notch 26 is designed to be positioned facing an opening 27 made in the wall of the middle 3 to receive the bolt 22 (FIG. 1A). Said opening 27 traverses the wall of the middle 3 at the flange 14, optionally in the middle of the flange 14.

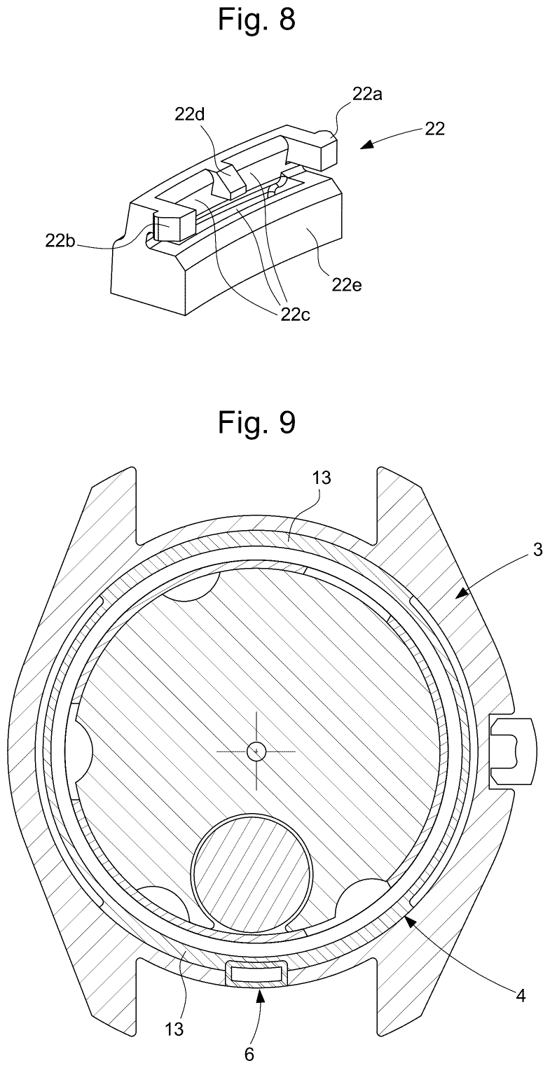

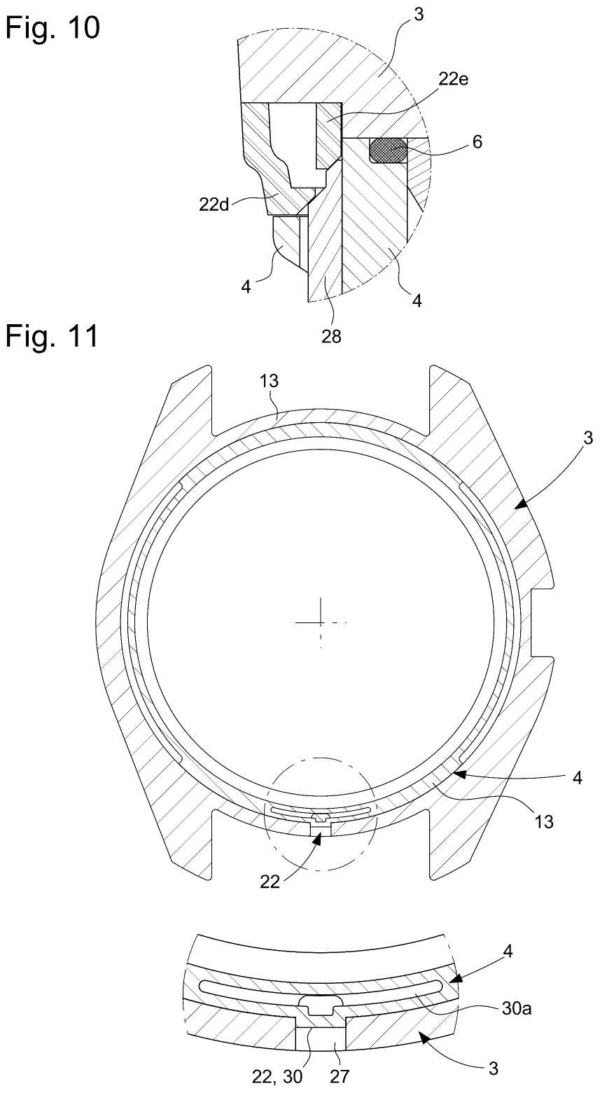

The bolt 22 according to the first variant seen in FIG. 8 is in the form of a flexible part with two hooks 22a, 22b at the lateral ends which hook onto the ends 13a, 13b of the flange 13 that frame the notch 26 in the back. The bolt 22 has three recesses 22c in the example, to add this flexibility to the part. The bolt 22 can also comprise a central tab 22d which separates two recesses 22c near two hooks 22a, 22b. To lock the bayonet connection in rotation, the bolt is clamped to bring the two hooks 22a, 22b together and conjointly inserted into the opening 27 in the middle and into the notch 26 in the back. The two hooks 22a, 22b then return to their positions to hook onto the ends 13a, 13b of the flange. To remove the bolt, a tool 28 has to be inserted into a slot 29 in the back 4 (FIG. 1A). As shown in FIG. 10, the tool 28 presses on the tab 22d and on one wall 22e below the tab 22d, which retracts the hooks on the bolt and pushes it out of the middle.

According to a second variant, the bolt 22 is arranged directly in the back 4. Instead of the notch 26, the back 2 is provided with a flexible protruding portion 30 extending radially outwards from the back 4 at one of the flanges 13 (FIG. 11). The protruding portion 30 is made flexible by a recess 30a made in part of the flange 13 and optionally of the protruding portion 30. As a result, the back does not have a notch 26 to receive the bolt, while the middle 3 has an opening 27 to receive the protruding portion 30. When it is assembled with the bayonet connection, the protruding portion is compressed against the lateral wall of the bed 3a of the middle before dropping into the opening 27 of the case and resuming its shape. To remove the bolt, a tool (not shown) is inserted laterally into the opening 27 in the middle to compress the protruding portion 30 and rotationally release the back.

Once the bolt has been removed, the pre-assembled case can be disassembled by inserting a tool into the slot 31 or into circular holes (not shown) in the back 4 to rotate the back (FIG. 1A).

The watch head is assembled as follows. First, the case 2 is pre-assembled by following the steps below. The movement rest 5 is positioned within the middle 3 by placing the guide marks 18 on the movement rest 5 opposite the guide marks 19 on the middle 3. The joint 6 is positioned around the movement rest 5 and then the case 2 is closed with the back 4. The flanges 13 are positioned on the rim 17 in the places where there are no flanges 14. Then, by rotating the back 4 relative to the middle 3 using, for example, a tool inserted into the slot 31, one end of the flange 14 engages the open end of the groove 12. Then, if there is a bolt, it is embedded in the notch 26 in the back and in the opening 27 in the middle or, according to the other variant of the bolt, only in the opening 27 in the middle.

Once the case 2 has been pre-assembled, the movement and external parts are assembled from the side opposite to the back, as shown in FIG. 3. The movement 7 is inserted into the case with its guide marks aligned with the guide marks 18 on the movement rest 5. Preferentially, the dial 8 is attached beforehand to the movement 7 so as to be jointly inserted into the case (FIG. 7). the dial can be heat-welded to the movement. In a quartz watch, the movement 7 can comprise a compartment 7a for accommodating a detachable energy source 32 such as a battery. The hands 9, the glass 10 and the bezel 11 are then fitted. The glass can be soldered to the middle, with the bezel concealing the solder joint. The bezel can also be attached to the middle by ultrasonic welding, for example. The glass and the bezel can also optionally be glued together as a single piece, or there can be no bezel at all.

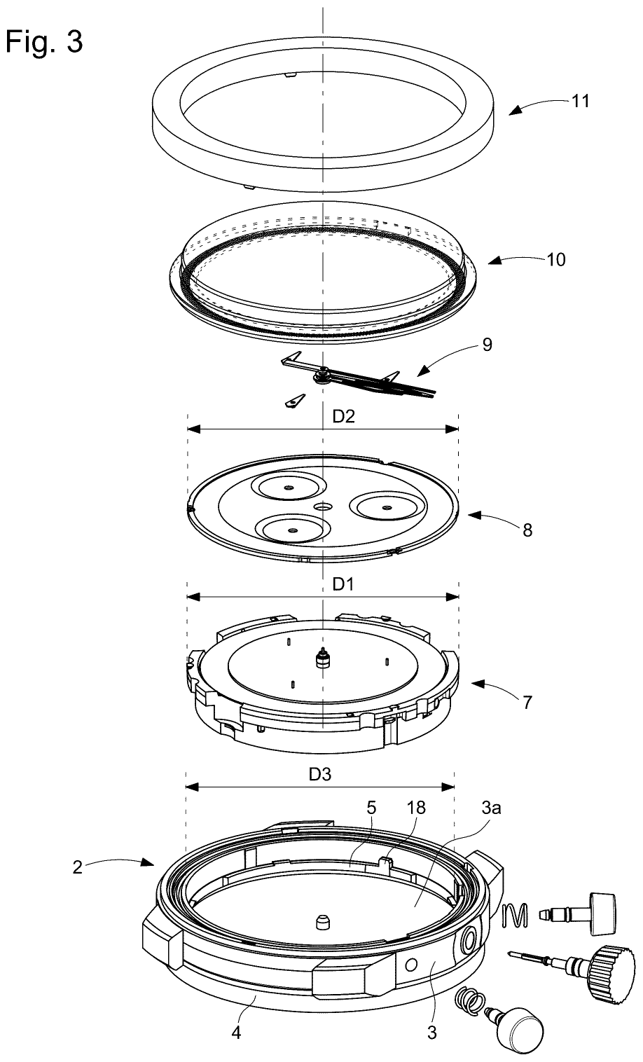

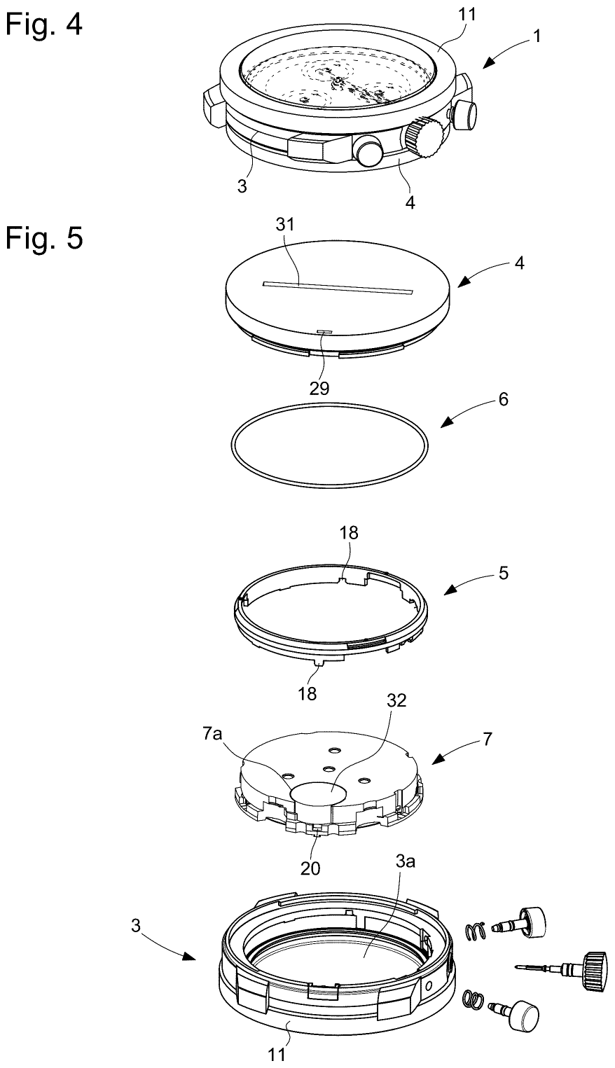

The resulting watch head 1 is shown in FIG. 4. The disassembly shown in FIG. 5 is carried out from the bottom. The watch head is turned over for easy access to the bottom 4. If there is a lock, it is first removed as described above. The back 4 is then removed from the watchcase 2 with the tool positioned in slot 31. Removing the back 4 enables the movement rest 5 to be removed. The movement 7 and dial can then be extracted through the bottom of the middle. Reassembly is also carried out from the bottom by first fitting the movement 7 into the bed 3a of the middle 3, with the guide marks 20 on the movement aligned with the guide marks on the middle. The movement rest 5 is then also positioned using its guide marks 18 and lastly, the back 4 is attached to the middle 3 using the bayonet connection or any reversible connection, possibly including the bolt.

1. A watch head (1) which can be assembled from the top and
disassembled from the bottom, with the bottom defining a lower position facing a back (4) and with the top defining an upper position opposite to the lower position, the watch head (1) comprising:
a pre-assembled case (2) comprising a middle (3) delimiting an inner bed (3a), the back (4) fitted with reversible fastening means on said middle (3) and a movement rest (5) mounted flush with a lower face on the middle (3);
a movement (7) mounted on the movement rest (5) within the pre-assembled case (2);
a dial (8) mounted on the movement (7); and
a glass (10) closing the pre-assembled case (2) at the end opposite to the back (4),
said dial (8) and said movement (7) having dimensions less than or equal to those of the dimensions of the bed (3a) inside the middle (3) so that the middle (3) can be traversed from above and from below.

2. The watch head (1) according to claim 1, in which the reversible fastening means are formed by a bayonet connection.

3. The watch head (1) according to claim 2, in which the back (4) comprises on its periphery (4a) at least a first flange (13) traversed by a groove (12) and in which the middle (3) comprises at least a second flange (14) protruding inside said middle (3), said groove (12) being open at one end to enable the second flange (14) to engage when the back (4) is rotated, the engagement of the second flange (14) in the groove (12) forming the bayonet connection.

4. The watch head (1) according to claim 3, in which the pre-assembled case (2) comprises a bolt (22) arranged on the bayonet connection to prevent any relative rotational movement between the middle (3) and the back (4).

5. The watch head (1) according to claim 4, in which the bolt (22) is positioned between the horns (23) of the middle (3).

6. The watch head (1) according to claim 4, in which the bolt (22) is a flexible part attached to the middle (3) and to the back (4), an opening (27) being made through the second flange (14) and the groove (12) communicating with a notch (26) made in the first flange (13), said notch (26) being positioned opposite the opening (27) to jointly receive the bolt (22).

7. The watch head (1) according to claim 6, in which the bolt (22) comprises two hooks (22a, 22b) for respectively hooking the ends (13a, 13b) of the first flange (13) that frame the notch (26) in the back (4).

8. The watch head (1) according to claim 6, in which the back (4) is traversed by a first slot (29) for receiving a first tool (28) in order to apply a force to said bolt (22), ensuring its withdrawal from the pre-assembled case (2).

9. The watch head (1) according to claim 4, in which the bolt (22) forms an integral part of the back (4) and is in the form of a flexible portion (30) protruding radially outwards from the back (4), and in which an opening (27) is made through the second flange (14), said flexible portion (30) being compressed against the middle (3) during assembly with the bayonet connection before dropping into the opening (27) of the middle (3) and resuming its shape to ensure locking, unlocking being ensured by a second tool introduced into the opening (27) of the middle (3) to compress the flexible portion (30).

10. The watch head (1) according to claim 2, in which the visible face of the back (4) comprises a second slot (31) or orifices for positioning a third tool for assembling and disassembling the back (4), ensuring that it is rotated relative to the middle (3).

11. The watch head (1) according to claim 1, in which the movement rest (5) comprises first guide marks (18) engaging jointly with second guide marks (19) on the middle (3) and third guide marks (20) on the movement (7).

12. The watch head (1) according to claim 1, in which said lower face of the middle (3) comprises a rim (17) recessed in a lateral wall delimiting the inner bed (3a) of the middle (3) and in which a shoulder (5c) is hollowed out on an upper face of the periphery (5a) of the movement rest (5) with said shoulder (5c) pressing on the rim (17) to assemble the movement rest (5) flush with the middle (3).

13. The watch head (1) according to claim 1, in which a detachable energy source (32) is nested in a compartment (7a) of the movement (7).

14. The watch head (1) according to claim 1, in which the dial (8) and the movement (7) have the same dimensions.

15. The watch head (1) according to claim 1, in which the dial (8) is soldered to the movement (7).

16. A method for assembling and disassembling the watch head (1) according to claim 1, comprising for the assembly the steps of:
pre-assembling the watchcase (2), pre-assembly consisting of:
assembling the movement rest (5) flush against the lower face of the middle (3),
fitting the joint (6) around the movement rest (5),
reversibly closing the middle (3) with the back (4) to obtain the pre-assembled case (2),
optionally fitting the bolt (22) to prevent any relative rotational movement between the back (4) and middle (3),
assembling from the top at least the movement (7), the dial (8), the glass (10) and optionally a bezel (11) to obtain the watch head (1),
and for disassembling the steps of:
removing the bolt (22) if there is a bolt (22),
disassembling the back (4) of the watchcase (2),
disassembling at least the joint (6), the movement rest (5) and the movement (7) from the bottom.
